(19) United States
(12) Patent Application Publication
(10) Pub. No.: US 2017/0089317 A1
(43) Pub. Date: Mar. 30, 2017

(54) WATER OUTLET DEVICE OF SELF POWER GENERATION

(71) Applicant: FUJIAN XIHE SANITARY WARE TECHNOLOGY CO., LTD., Nan'an City (CN)

(72) Inventors: Xiaofa LIN, Nan'an City (CN); Xiaoshan LIN, Nan'an City (CN); Qiqiao LIU, Nan'an City (CN); Xiaoqing DENG, Nan'an City (CN); Caibo GU, Nan'an City (CN)

(73) Assignee: FUJIAN XIHE SANITARY WARE TECHNOLOGY CO., LTD., Nan'an City (CN)

(21) Appl. No.: 15/064,007

(22) Filed: Mar. 8, 2016

(30) Foreign Application Priority Data
Sep. 29, 2015 (CN) 201510631371.4

(51) Int. Cl. F03B 11/00; B05B 1/18; F03B 11/02; F16K 31/06; F03B 1/02; F03B 13/00; B05B 1/16; B05B 12/00

(52) U.S. Cl. CPC F03B 11/004; B05B 1/1618; B05B 1/18; B05B 12/002; F16K 31/0655; F03B 1/02; F03B 13/00; F03B 11/02; F05B 2240/60

(57) ABSTRACT

A water outlet device with self power generation has a fixing unit that includes an inlet waterway and at least one first outlet waterway and at least one second outlet waterway. The first outlet waterway is connected to the inlet waterway through an electric-control valve and the second outlet waterway is connected to the inlet waterway. A power generation mechanism is fixed in the fixing unit; a fast energy storage component; a control unit comprises a control circuit and a control module; the control circuit, fast energy storage component, electric-control valve and the power generation mechanism are in electric-connection, the electric energy generated by the power generation mechanism is stored by the fast energy storage component after rectification, the control circuit gets the electric energy through the fast energy storage component and controls the electric-control valve.

### FIELD OF THE INVENTION

The present invention relates to sanitary ware, especially to a water outlet device of self power generation.

### BACKGROUND OF THE INVENTION

The existing shower is normally with at least two water outlet function of at least two kinds of spray, such as massage spray, shower spray and so on. For this kind of shower, it normally takes the way of using mechanical switch to change the spray outlet function, such as the rotation switch, the swing switch and so on, however, some disadvantages exist in the mechanical switch way like not convenience in operation, not effort saving, lack of sense of technology and not following the trend of social development.

A utility model of Chinese patent No. 200520121206.6 disclosed an electromagnetic button type shower which uses solenoid valve cooperating with button to control the water outlet function of shower, and takes the electric energy generated by the hydroelectric power generation device under the impact of water flow to charge the solenoid valve, or uses the chargeable battery to provide the electric energy to the solenoid valve. Although this shower overcomes above disadvantages, exists following defects as well:

The way of generating electric energy through hydroelectric power generation device that provides the generated electric energy directly to the solenoid valve at the same time is not practical in actual application progress, because the working power necessary for the solenoid valve is not matched with the actual output power of the hydroelectric power generation device and is with big difference from it; When the original status of each solenoid valve is close, the hydroelectric power generation device can't generate electric energy to charge the solenoid valve so can't turn on the solenoid valve.

The way of using battery is not helpful for energy conservation and environmental protection, and there is potential safety hazard in the condition of over-charging or being impacted by external force when using battery; High charging requirement for battery charging is common because low current or low voltage is difficult to charge into the battery.

### SUMMARY OF THE INVENTION

The object of the present invention is to offer a water outlet device of self power generation, which overcome the disadvantages of utilizing solenoid valves cooperated with power generation mechanism or battery to control the shower outlet spray function in switch way at the prior art.

One technical solution to the above technical problems for the present invention is that:

A water outlet device of self power generation, wherein it comprises:

A fixing unit, it has an inlet waterway and at least one first outlet waterway and at least one second outlet waterway, the first outlet waterway is connected to the inlet waterway through an electric-control valve, the second outlet waterway is normally open and connected to the inlet waterway;

A power generation mechanism, it is fixed in the fixing unit and generate electric energy by the impact of the water flow in the inlet waterway;

A fast energy storage component, it is used for storing electric energy generated by the power generation mechanism;

A control unit, it comprises a control circuit and a control module which is used for activating the control circuit;

The control circuit, fast energy storage component, electric-control valve and the power generation mechanism are in electric-connection, the electric energy generated by the power generation mechanism is stored by the fast energy storage component after rectification, the control circuit gets the electric energy through the fast energy storage component and controls the on and off of the electric-control valve.

In another preferred embodiment, said power generation mechanism comprises a generator, an impeller and a drive body disposed with an outlet water hole and an oblique water hole which is connected to the inlet waterway, the impeller is fixed in the drive body and connected to the shaft of the generator.

In another preferred embodiment, said impeller is in turbo structure.

In another preferred embodiment, said driving body comprises a drive plate disposed

with said oblique water hole and a hollow shell disposed with said outlet water hole, the hollow shell is fixed to the case of the generator or in the integrated mold with the case of the generator, the drive plate is connected to the hollow shell and cover on it.

In another preferred embodiment, said fast energy storage component is a super capacitor.

In another preferred embodiment, said control module is a touch panel or an infrared sensing module which is in electric connection with said control circuit; or, said control module can be a remote controller which could communicate with said control circuit in wireless way.

In another preferred embodiment, said fixing unit comprises a base, a top cover with an inlet hole and a side cover, the base is disposed with a first cavity and at least one second cavity which is communicating with the first cavity; said power generation mechanism is installed in the first cavity, the top cover is covered on the base and cooperated with the base to form the inlet waterway connected to the first cavity; said electric-control valve is set in the second cavity, said first outlet waterway is formed on the base near the outlet hole of the electric-control valve and is connected to the outlet hole of the electric-control valve; the side cover blocks the first cavity from the side and helps to form said second outlet waterway connected to the first cavity; the connection wiring terminal of said power generation mechanism can go through out of the side cover.

In another preferred embodiment, said fixing unit is a shower body, the shower body is also provided with water outlet function which is in one-to-one correspondence connection with said first outlet waterway and second outlet waterway, said control circuit and fast energy storage component are installed in the shower body, said control module is fixed out of the shower body, or, said control module can be a remote controller which could communicate with said control circuit in wireless way.

In another preferred embodiment, also comprises a shower body of at least two water outlet function; said fixing unit is installed in the shower body, inlet waterway of said fixing unit is connected to the inlet end of the shower body, the first outlet waterway and second outlet waterway of said fixing unit are in one-to-one correspondence connection with the water outlet function of the shower body; said control circuit and fast energy storage component are installed in the shower body or the fixing unit, said control module is fixed out of the shower body, or, said control module can be a remote controller which could communicate with said control circuit in wireless way.

Another technical solution to the above technical problems for the present invention is that: A water outlet device of self power generation, wherein it comprises:

A fixing unit, it has an inlet waterway and at least two outlet waterway, and each outlet waterway is connected to the inlet waterway through an electric-control valve;

A power generation mechanism, it is fixed in the fixing unit and generate electric energy by the impact of the water flow in the inlet waterway;

A fast energy storage component, it is used for storing electric energy generated by the power generation mechanism;

A control unit, it comprises a control circuit and a control module which is used for activating the control circuit;

The control circuit, fast energy storage component, electric-control valve and the power generation mechanism are in electric-connection, the electric energy generated by the power generation mechanism is stored by the fast energy storage component after rectification, the control circuit gets the electric energy through the fast energy storage component and controls the on and off of each of the electric-control valves, and at least one electric-control valve is normally in on status, or, when said inlet waterway stops getting water inlet, the control circuit can control at least one electric-control valve to keep in on status.

In another preferred embodiment, said power generation mechanism comprises a generator, an impeller and a drive body disposed with an outlet water hole and an oblique water hole which is connected to the inlet waterway, the impeller is fixed in the drive body and connected to the shaft of the generator.

In another preferred embodiment, said impeller is in turbo structure.

In another preferred embodiment, said fast energy storage component is a super capacitor.

In another preferred embodiment, said fixing unit comprises a base, a top cover with an inlet hole and a side cover, the base is disposed with a first cavity and at least two second cavity each of which is communicating with the first cavity respectively; said power generation mechanism is installed in the first cavity, the top cover is covered on the base and cooperated with the base to form the inlet waterway connected to the first cavity; one said electric-control valve is connected in each of the second cavity, said first outlet waterway is formed on the base near the outlet hole of the electric-control valve and is connected to the outlet hole of the electric-control valve; the side cover blocks the first cavity from the side, the connection wiring terminal of said power generation mechanism can go through out of the side cover.

In another preferred embodiment, said fixing unit is a shower body, the shower body is also provided with water outlet function which is in one-to-one correspondence connection with said at least two outlet waterway, said control circuit and fast energy storage component are installed in the shower body, said control module is fixed out of the shower body, or, said control module can be a remote controller which could communicate with said control circuit in wireless way.

In another preferred embodiment, also comprises a shower body of at least two water outlet function; said fixing unit is installed in the shower body, inlet waterway of said fixing unit is connected to the inlet end of the shower body, the outlet waterways of said fixing unit are in one-to-one correspondence connection with the water outlet function of the shower body; said control circuit and fast energy storage component are installed in the shower body or the fixing unit, said control module is fixed out of the shower body, or, said control module can be a remote controller which could communicate with said control circuit in wireless way.

Comparing to the existing known technology, the technical solution of the present invention has advantages as follows:

1. The electric energy generated by power generation mechanism of present invention can be stored by the fast energy storage component firstly then transferred to the control circuit for use, it can satisfy electric power requirement for opening or closing the electric-control valve through control circuit, and it is energy-saving and friendly to environment of using the fast energy storage component which can be charged and discharged in circular way, and be with long service life and no patient safety hazard;

2. In the condition of adequate water supply, the power generation mechanism can generate electric energy anytime as required to ensure that at the starting using time there is enough power capacity to be provided to the control circuit to open the electric-control valve, the condition of failing to open the electric-control valve is evitable in the reason of the power generation mechanism no power generation at the starting using time.

3. The power generation efficiency of power generation mechanism can be increased as the impeller of power generation mechanism of present invention designed in turbo structure;

4. In the present invention the power generation mechanism, electric-control valve and the fixing unit are designed to be combined together to form a set module, in which way can make the product structure compact and with small volume, as well as more space reserved for product outlook design, and convenience in mass production to achieve wide application for the water outlet device.

The present invention will be further described with the drawings and the embodiments to make the present invention more clear and well-known. It should be noted that, the water outlet device of self power generation of the present invention is not limited to embodiments.

### BRIEF DESCRIPTION OF THE DRAWINGS

FIG. 1 illustrates an exploded diagram of parts of the water outlet device of the present invention according to embodiment 1.

FIG. 2 illustrates an exploded diagram of the power generation mechanism of the present invention according to embodiment 1.

FIG. 3 illustrates an exploded diagram of the control unit of the present invention according to embodiment 1.

FIG. 4 illustrates a circuit block diagram of the present invention according to embodiment 1.

FIG. 5 illustrates a schematic diagram of the water outlet device of the present invention according to embodiment 1 (not includes shower body).

FIG. 6 illustrates a sectional diagram 1 of the water outlet device of the present invention according to embodiment 1 (not includes shower body).

FIG. 7 illustrates a sectional diagram 2 of the water outlet device of the present invention according to embodiment 1 (not includes shower body).

FIG. 8 illustrates an exploded diagram of the water outlet device of the present invention according to embodiment 1.

FIG. 9 illustrates a sectional of the water outlet device of the present invention according to embodiment 1.

FIG. 10 illustrates a front view of the water outlet device of the present invention according to embodiment 1.

FIG. 11 illustrates a front view of another type of the water outlet device of the present invention according to embodiment 1.

FIG. 12 illustrates an exploded diagram of parts of the water outlet device of the present invention according to embodiment 2.

FIG. 13 illustrates a schematic diagram of the water outlet device of the present invention according to embodiment 2 (not includes shower body).

### DETAILED DESCRIPTION OF THE EMBODIMENTS

### Embodiment 1

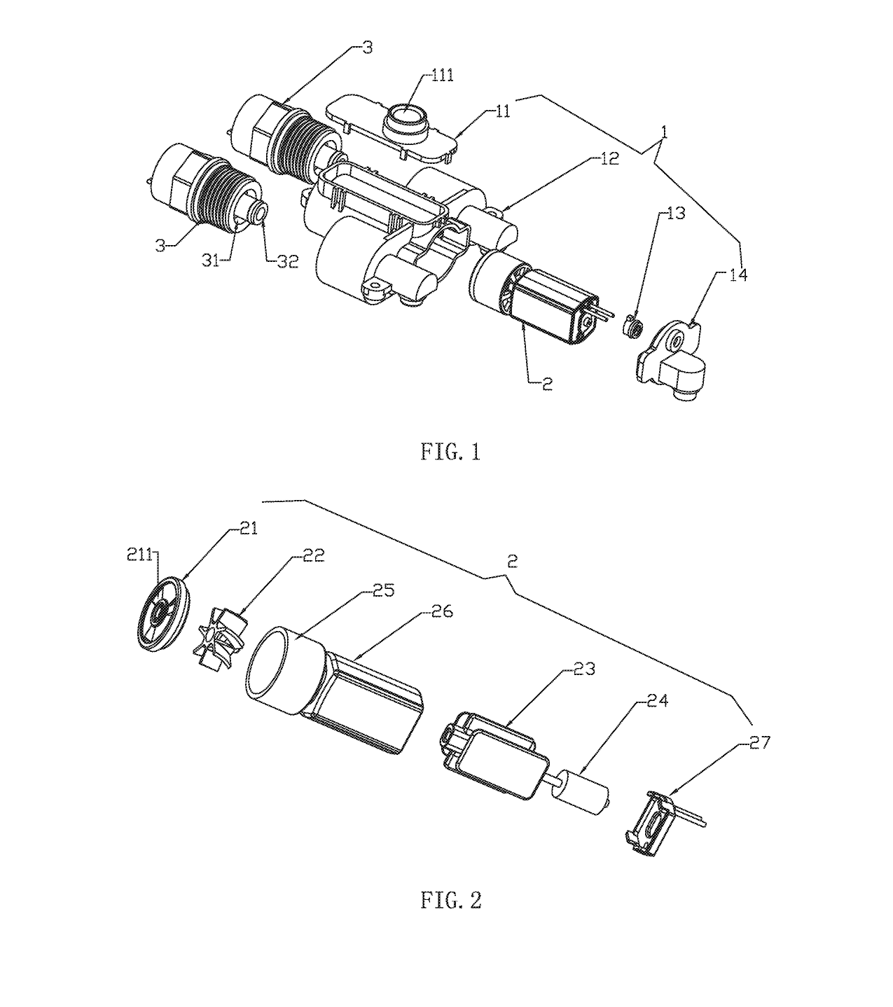

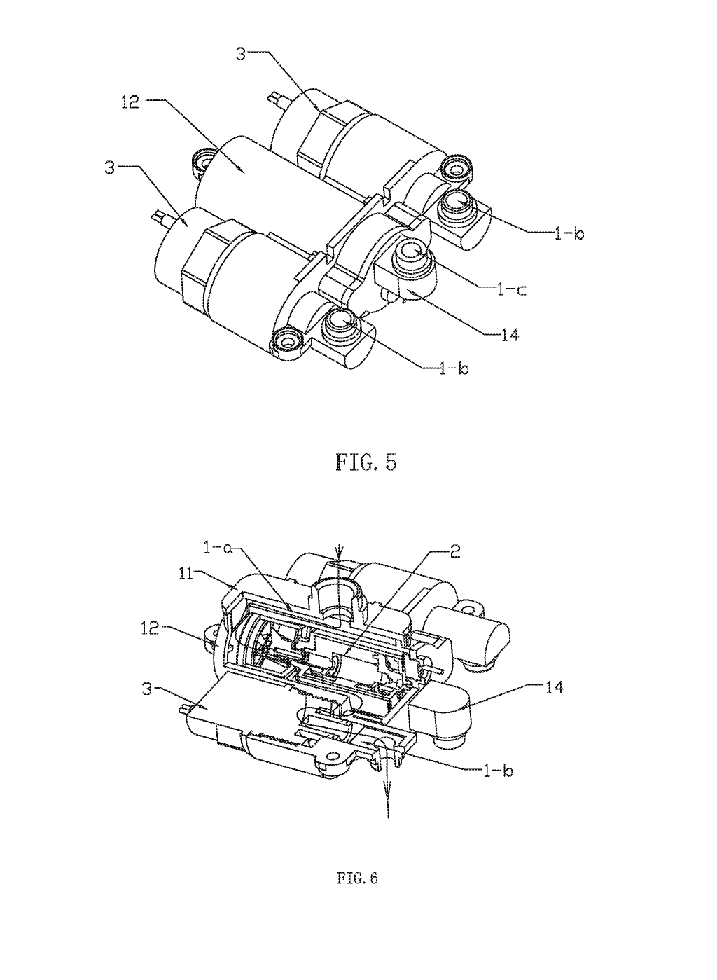

Please referring to FIGS. 1-7, a water outlet device of self power generation of present invention, it comprises:

The fixing unit 1, it has an inlet waterway 1-a and two first outlet waterway 1-b (the quantity of first outlet waterway 1-b is not limited to two) and one second outlet waterway 1-c (the quantity of second outlet waterway 1-c is not limited to one); each first outlet waterway 1-b is connected to the inlet waterway 1-a through one electric-control valve, the second outlet waterway is normally open (just keep in open status for water go-through) and connected to the inlet waterway 1-a; said electric-control valve use valve assembly triggered by electric to control the inner loop open or close, in this embodiment, said electric-control valve takes solenoid valve preferably;

The power generation mechanism 2, it is fixed in the fixing unit 1 and generate electric energy by the impact of the water flow in the inlet waterway 1-a;

The fast energy storage component, it is used for storing electric energy generated by the power generation mechanism 2;

The control unit 4, it comprises a control circuit 45 and a control module which is used for activating the control circuit 45;

The control circuit 45, fast energy storage component, solenoid valve 3 and the power generation mechanism 2 are in electric-connection, the electric energy generated by the power generation mechanism 2 is stored by the fast energy storage component after rectification, the control circuit 45 gets the electric energy through the fast energy storage component and controls the on or off of the solenoid valve 3. In this embodiment, as FIG. 1 shown, said fixing unit 1 comprises a base 12, a top cover 11 with an inlet hole 111 and a side cover 14, the base 12 is disposed with a first cavity 121 and two second cavity 122, two second cavity 122 are communicating with the first cavity 121 respectively and located at the sides of the first cavity 121. Said power generation mechanism 2 is installed in the first cavity 121, the top cover 11 is covered on the base 12 and cooperated with the base 12 to form the inlet waterway 1-a connected to the first cavity 121. Each solenoid valve 3 is in threaded connection in corresponding second cavity 122 respectively, meanwhile inlet hole 31 and outlet hole 32 of solenoid valve 3 are located in second cavity 122, said first outlet waterway 1-b is formed on the base 12 near the outlet hole 32 of the solenoid valve 3 and is connected to the outlet hole 32 of the solenoid valve 30. The side cover 14 blocks the first cavity 121 from the side and helps to form said second outlet waterway 1-c connected to the first cavity 121. The connection wiring terminal of said power generation mechanism 2 can go through of the side cover 14, for the purpose of sealing, there is a sealing cover 13 set at the inner side of the side cover 14 to make the connection wiring terminal of the power generation mechanism 2 go through. The fixing unit 1 could be a shower body, the shower body is also provided with water outlet function which is in one-to-one correspondence connection with the first outlet waterway 1-b and second outlet waterway 1-c, at this time, the water outlet device is a shower directly, and this shower could be a hand-held shower or a top-spray shower.

In this embodiment, as FIG. 2 shown, the power generation mechanism 2 comprises a generator, an impeller 22 and a drive body disposed with an oblique water hole 211 and an outlet water hole connected to the inlet waterway 1-a, the impeller 22 is designed in turbo structure preferably and is fixed in the drive body and connected to the shaft of the generator. The driving body comprises a drive plate 21 and a hollow shell 25, the drive plate 21 is disposed with said oblique water hole 211, one end of the hollow shell 25 is disposed with said outlet water hole and the other end is open and connected to the drive plate 21. The generator comprises a case 26, a stator 23, a rotator 24 and a cover plate 27, the stator 23 and the rotator 24 is set in the case 26, the cover plate 27 is disposed with two connection terminals and is covered on the end of the case 26, the two connection terminals are in electric connection with the coil of the stator 23. The hollow shell 25 is in integrated mold with the case 26 and set on the other end of the case 26, the shaft of the rotator 24 goes through the other end of the case 26 and gets concentric connection with the impeller 22 in the shell 25. Said power generation mechanism 2 lies in the first cavity 121 of the base 12 at the position of the impeller part near the inlet waterway 1-a and the cover plate 27 towards the side cover 14 of the fixing unit 1.

In this embodiment, said fast energy storage component is a super capacitor 5.

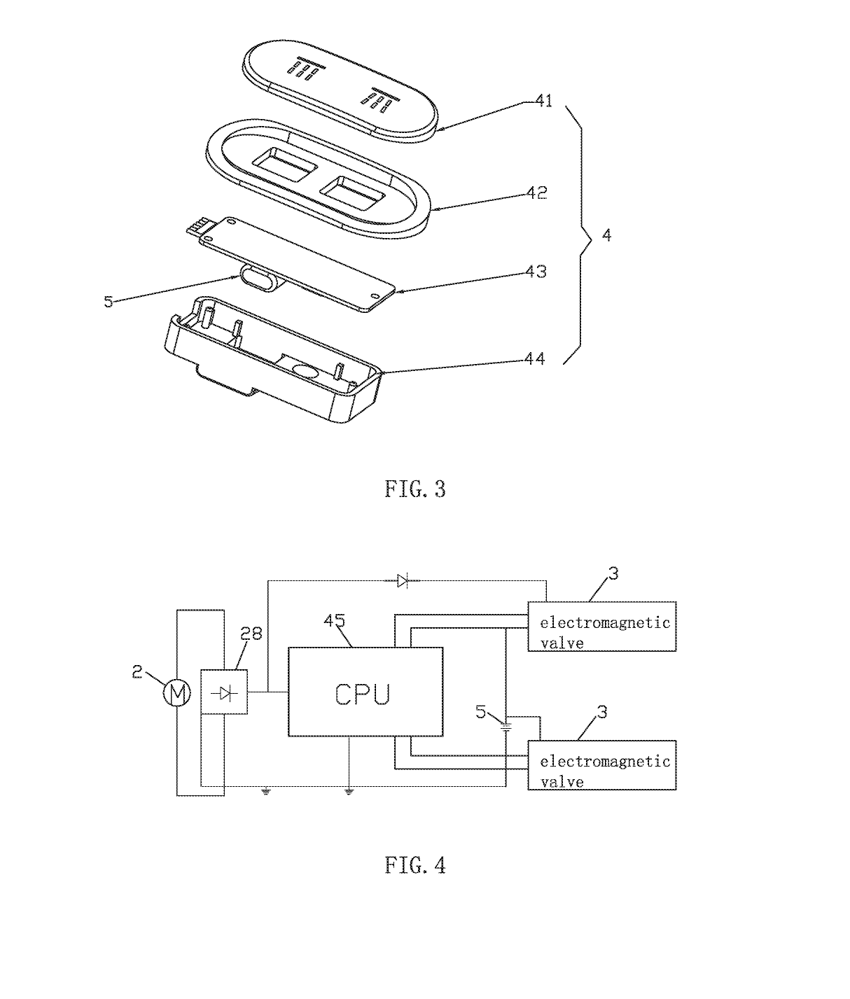

In this embodiment, as FIG. 3 shown, said control unit 4 not only comprises said control circuit 45 and said control module, but also comprises a circuit box, the circuit box is provided with a box seat 44 and a box cover 42, said control circuit 45 and super capacitor 5 are integrated on the circuit board 43 which is installed in the box seat 44, said control module is set to be a touch panel 41, which is embedded out of the box cover 42 and is in electric connection with the control circuit 45. Said control module is also can be an infrared sensing module, or, said control module can be a remote controller which could communicate with said control circuit 45 in wireless way.

In this embodiment, the circuit block diagram of the present invention is shown as FIG. 4, the electric energy generated by the power generation mechanism 2 is rectified by rectification circuit (the rectification circuit is specified to be a bridge rectifier 28 which is consisting of diodes) then directly or goes through the control circuit 45 to be stored by the super capacitor 5, the important part of said control circuit 45 is CPU, the signal output terminal of the control circuit is in electric connection with two solenoid valve 3 for controlling on or off of the solenoid valve 3. The electric energy generated by the power generation mechanism 2 also could be rectified by a commutator set on power generation mechanism 2 before output then stored by super capacitor 5.

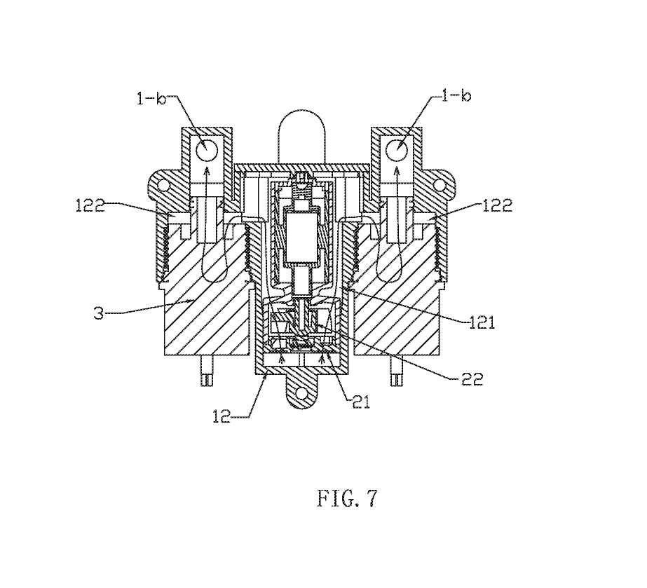

In original status, two solenoid valves 3 can be in on or off status (according to factory setting). When water goes into the inlet waterway 1-a of the fixing unit 1, water goes through the oblique water hole of the power generation mechanism 2 to drive the impellor 22 to rotate, then water goes out of the second outlet waterway 1-c of the fixing unit 1 finally. As the impeller 22 rotated, the rotator 24 of the generator does the motion of cutting magnetic line to make induced electromotive force which can be output through connection terminals after rectification and be stored by the super capacitor 5, this charging process is in short time like about 10 s. At this time, user can send order to the control circuit 45 by operation on the touch panel 41 to control the on or off of each solenoid valve 3, as the consequence to make the first outlet waterway 1-b open or close for water pass-through corresponding to the status of each solenoid valve 3, both solenoid valve 3 can be turned on or turned off in different time period, as FIG. 6 shown, both solenoid valve 3 can be turned on or turned off in same time period, as FIG. 7 shown, also, the working status of both solenoid valve 3 is independent without the influence of each other.

The water outlet device of self power generation in present invention, the set module consisting of the fixing unit 1, power generation mechanism 2, the fast energy storage component and the control unit 4 can be applied in shower as well as in faucet and so on.

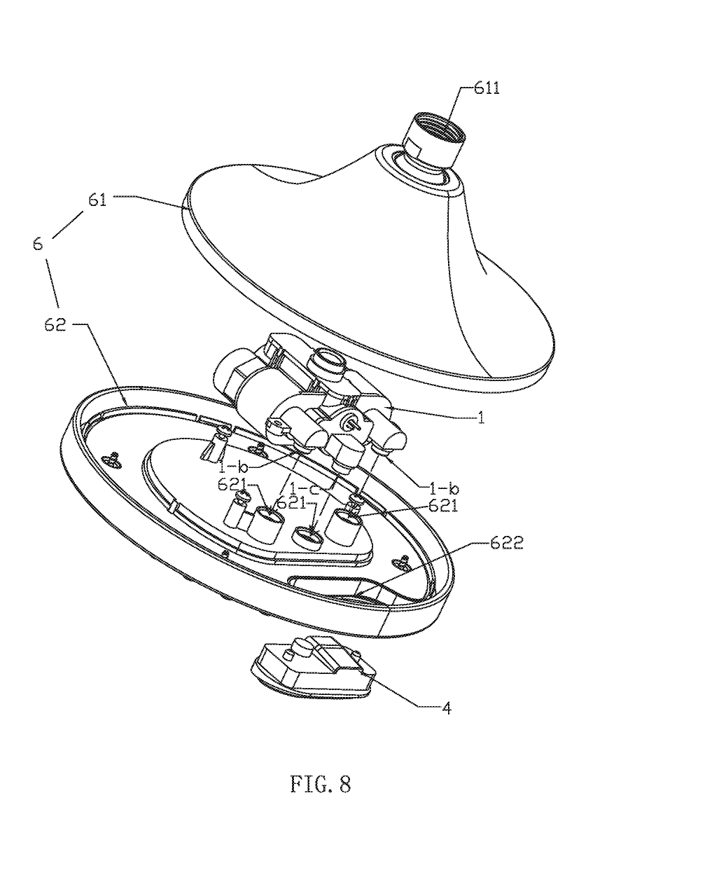

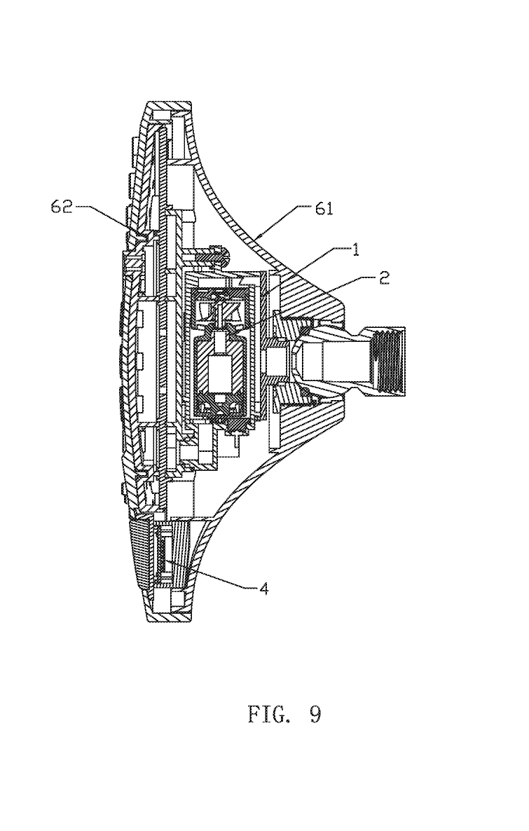

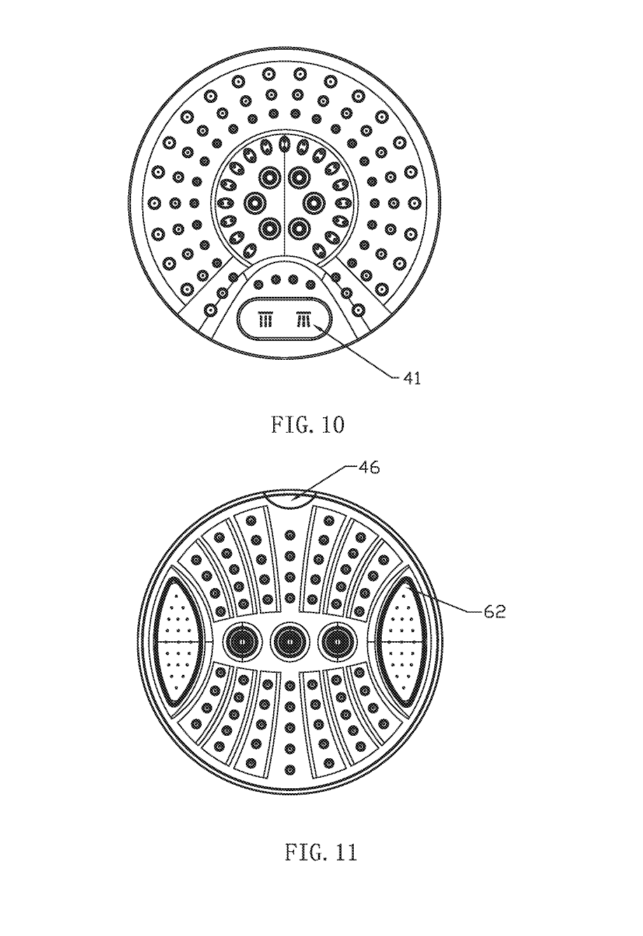

Please referring to FIG. 8-10, the water outlet device of self power generation in present invention, also comprises shower body 6 which is used to make the water outlet device to be a shower. There is three water outlet function (just three types of water outlet in three spray way) for the shower body 6, said fixing unit 1 is installed in the shower body 6, inlet waterway of said fixing unit is connected to the inlet end of the shower body, inlet waterway 1-a of said fixing unit 1 is connected to the inlet end of the shower body 6, two outlet waterway 1-b and one second inlet waterway 1-c of said fixing unit 1 are in one-to-one correspondence connection with the water outlet function of the shower body. The circuit box of said control unit 4 is installed in the shower body 6, and said touch panel 41 is fixed out of the shower body 6.

In this embodiment, the water outlet device is specified to be a top-spray shower (the selective shower type is not limited to top-spray shower), the shower body 6 comprises a cover assembly 62 with said three types of outlet spray function as well as a trumpet-shaped outer shell 61 with inlet end 611, the cover assembly 62 is disposed with three water go-through holes 621 which are respectively connected to two first outlet waterway 1-b and one second outlet waterway 1-c of fixing unit 1, the three water go-through holes 621 are correspondingly communicated with three types of outlet spray function of the cover assembly 62. The cover assembly 62 is also provided with a mold cavity 622 inside to accommodate said circuit box, and touch panel 41 is set on the outer surface of the cover assembly 62.

When water goes into the inlet end 611 of the shower body 6, the water flow is through the inlet waterway 1-a of the fixing unit 1 and is going into the oblique water hole 211 of the power generation mechanism 2 to drive the impeller 22 to rotate, then finally flow towards the cover assembly 62 through the second outlet waterway 1-c of the fixing unit 1 to make the cover assembly 62 accomplish one type of outlet spray function. As the impeller 22 rotated, the rotator 24 of the generator does the motion of cutting magnetic line to make induced electromotive force which can be output through connection terminals after rectification and be stored by the super capacitor 5. At this time, user can send order to the control circuit 45 by operation on the touch panel 41 to control the on or off of each solenoid valve 3, as the consequence to make the first outlet waterway 1-b open or close for water pass-through corresponding to the working status of each solenoid valve 3, and then make the cover assembly 62 accomplish certain type of outlet spray function as required.

Said touch panel 41 can be substituted by an infrared sensing module 46, as FIG. 11 shown, the infrared sensing module 46 comprises an infrared emission element and an infrared receiving element, in the using process, when the human hands or other obstacle get close to the infrared emission element, the signal is sent out from the infrared emission element to the infrared receiving element by which the signal would be transferred to the control circuit 45 to control the on or off of the solenoid valve 3. Furthermore, said touch panel 41 can be substituted by a remote controller.

### Embodiment 2

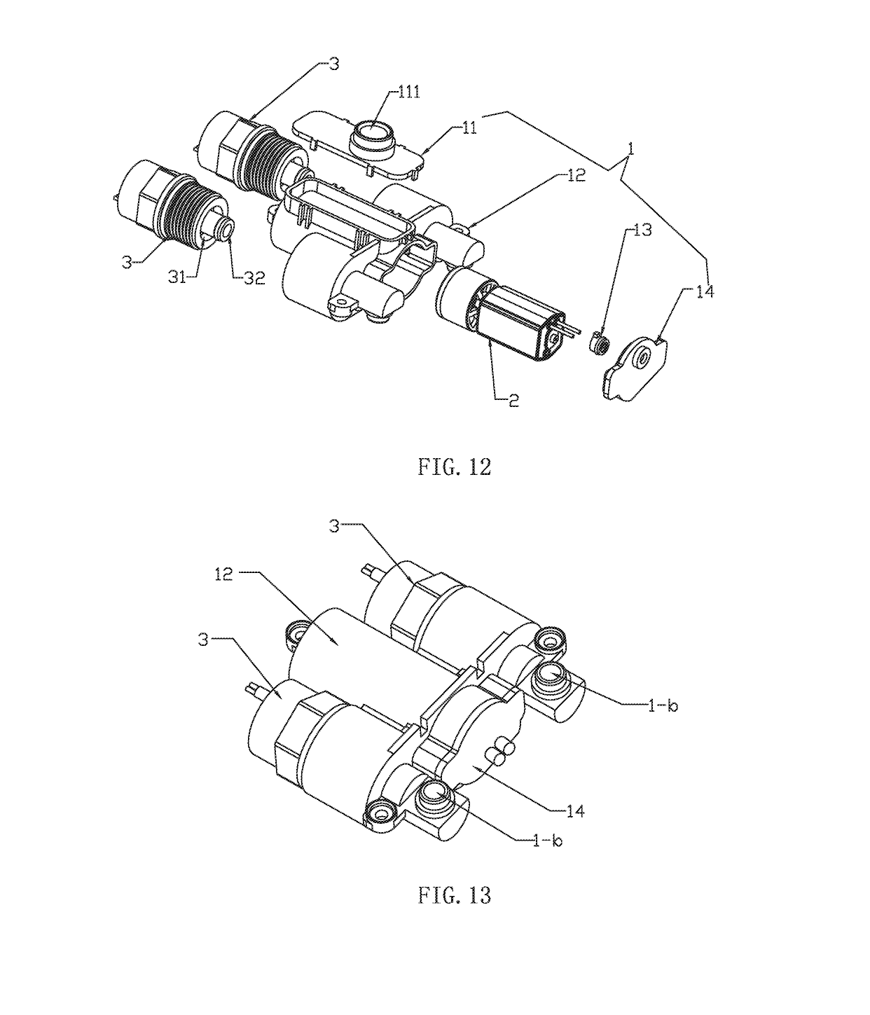

Please referring to FIG. 12-13, a water outlet device of self power generation in present invention, it comprises:

The fixing unit 1, it has an inlet waterway and two outlet waterway 1-b (the quantity of outlet waterway 1-b is not limited to two), each outlet waterway 1-b is connected to the inlet waterway through one electric-control valve, same as embodiment 1, said electric-control valve takes solenoid valve 3 preferably;

The power generation mechanism 2, it is fixed in the fixing unit 1 and generate electric energy by the impact of the water flow in the inlet waterway;

The fast energy storage component, it is used for storing electric energy generated by the power generation mechanism 2;

The control unit, it comprises a control circuit and a control module which is used for activating the control circuit;

The control circuit, fast energy storage component, solenoid valve 3 and the power generation mechanism 2 are in electric-connection, the electric energy generated by the power generation mechanism 2 is stored by the fast energy storage component after rectification, the control circuit gets the electric energy through the fast energy storage component and controls the on or off of the solenoid valve 3, when water stops flowing in said inlet waterway, the control circuit will control at least one solenoid valve in on status. Herein, said control circuit could make control of each solenoid valve 3 in switch way, every time when water stops flowing in inlet waterway, at least one solenoid valve will keep in on status, or, the control circuit could make control of each solenoid valve 3 independently, just the working status of on or off for every solenoid valve is independent and without any influence to each other, in this condition, the control circuit only need to control the working status of one or several solenoid valve to be on when water stops flowing in inlet waterway.

The design of the power generation mechanism 2 and the control unit is the same as embodiment 1, so no further illustration in embodiment 2.

Said fast energy storage component is a super capacitor.

In this embodiment, said fixing unit 1 comprises a base 12, a top cover 11 with an inlet hole 111 and a side cover 14, the base 12 is disposed with a first cavity 121 and two second cavity 122, two second cavity 122 are communicating with the first cavity 121 respectively; said power generation mechanism 2 is installed in the first cavity 121, the top cover 11 is covered on the base 12 and cooperated with the base 12 to form the inlet waterway connected to the first cavity 121. Each solenoid valve 3 is in threaded connection in corresponding second cavity 122 respectively, meanwhile inlet hole 31 and outlet hole 32 of solenoid valve 3 are located in second cavity 122, said first outlet waterway 1-b is formed on the base 12 near the outlet hole 32 of the solenoid valve 3 and is connected to the outlet hole 32 of the solenoid valve 30. The side cover 14 blocks the first cavity 121 from the side, the connection wiring terminal of said power generation mechanism 2 can go through of the side cover 14, for the purpose of sealing, there is a sealing cover 13 set at the inner side of the side cover 14 to make the connection wiring terminal of the power generation mechanism 2 go through. Additionally, the fixing unit 1 could also directly be a shower body.

In original status, one of the solenoid valves 3 could be in on status while the other one is in off status (or, in original status, two solenoid valves 3 are both in on status). When water goes into the inlet waterway of the fixing unit 1, water goes through the oblique water hole of the power generation mechanism 2 to drive the impellor 22 to rotate, and water finally goes out of corresponding outlet waterway which is communicated with the solenoid valve in on status. As the impeller rotated, the rotator of the generator does the motion of cutting magnetic line to make induced electromotive force which can be output through connection terminals after rectification and be stored by the super capacitor, this charging process is in short time like about 10 s. At this time, user can send order to the control circuit by operation on the touch panel to control the on or off of two solenoid valve. When water stops flowing in the inlet waterway of the fixing unit 1, two solenoid valves can be kept in one-on and one-off status by memory control of the control circuit, (or, two solenoid valves could be both kept in on status), ensure that when next flow goes into the inlet waterway of the fixing unit 1, there will be at least one outlet waterway with water flowing out, as to drive the power generation mechanism 2 to generate electric energy normally.

The water outlet device of self power generation in present invention, also comprises shower body which is used to make the water outlet device to be a shower. There is two water outlet function (just two types of water outlet, in two spray way) for the shower body, said fixing unit is installed in the shower body 6 by screw fastener, inlet waterway of said fixing unit is connected to the inlet end of the shower body, two outlet waterway of said fixing unit are in one-to-one correspondence connection with the water outlet function of the shower body. The circuit box of said control unit is installed in the shower body, and said touch panel is fixed on the surface of the shower body.

The present invention could be a top-spray shower, or a hand-held shower as well. When water goes into the inlet end of the shower body, the water flow is through the inlet waterway of the fixing unit and is going into the oblique water hole of the power generation mechanism to drive the impeller to rotate, then finally flow towards the cover assembly through the outlet waterway which is communicated with the solenoid valve in on status, then make the cover assembly 62 accomplish one type of outlet spray function. As the impeller rotated, the rotator of the generator does the motion of cutting magnetic line to make induced electromotive force which can be output through connection terminals after rectification and be stored by the super capacitor. At this time, user can send order to the control circuit by operation on the touch panel to control the working status of the two solenoid valves, just turn off the open solenoid valve, turn on the close solenoid valve, to change the outlet function of the cover assembly in switch way.

### Embodiment 3

A water outlet device of self power generation in present invention, the difference from embodiment 2 is that: one of the solenoid valves is a normal open solenoid valve (just in on status even without electricity connection), while others are normal close solenoid valves. The control circuit gets the electric energy through the fast energy storage component to control the on or off status of each solenoid valve.

When water goes into the inlet waterway of the fixing unit, water goes through the oblique water hole of the power generation mechanism to drive the impellor to rotate, then water finally goes out of the outlet waterway which is communicated with the solenoid valve normally in on status. As the impeller rotated, the rotator of the generator does the motion of cutting magnetic line to make induced electromotive force which can be output through connection terminals after rectification and be stored by the super capacitor, this charging process is in short time like about 10 s. At this time, user can send order to the control circuit by operation on the touch panel to control the on or off of corresponding solenoid valve: just turn off the normal open solenoid valve, turn on the normal close solenoid valve, or, only turn on the normal close solenoid valve. When water stops flowing in the inlet waterway of the fixing unit, the normal open solenoid valves will be kept open or returned to open status to ensure that when next flow goes into the inlet waterway of the fixing unit, there will be one outlet waterway with water flowing out, as to drive the power generation mechanism 2 to generate electric energy normally.

The water outlet device of self power generation in present invention, also comprises shower body which is used to make the water outlet device to be a shower. There is two water outlet function (just two types of water outlet in two spray way) for the shower body, said fixing unit is installed in the shower body 6 by screw fastener, inlet waterway of said fixing unit is connected to the inlet end of the shower body, two outlet waterway of said fixing unit are in one-to-one correspondence connection with the water outlet function of the shower body. The circuit box of said control unit is installed in the shower body, and said touch panel is fixed out of the shower body.

The present invention could be a top-spray shower, or a hand-held shower as well. When water goes into the inlet end of the shower body, the water flow is through the inlet waterway of the fixing unit and is going into the oblique water hole of the power generation mechanism to drive the impeller to rotate, then finally flow towards the cover assembly through the outlet waterway which is communicated with the solenoid valve in normally on status, then make the cover assembly accomplish one type of outlet spray function. As the impeller rotated, the rotator of the generator does the motion of cutting magnetic line to make induced electromotive force which can be output through connection terminals after rectification and be stored by the super capacitor. At this time, user can send order to the control circuit by operation on the touch panel to control the working status of the two solenoid valves: just turn off the normal open solenoid valve, turn on the normal close solenoid valve, as to switch the outlet spray function of the cover assembly, or, just only turn on the normal close solenoid valve, as to make the cover assembly accomplish two types of outlet spray function.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A water outlet device of self power generation, wherein it comprises:
A fixing unit, it has an inlet waterway and at least one first outlet waterway and at least one second outlet waterway, the first outlet waterway is connected to the inlet waterway through an electric-control valve, the second outlet waterway is normally open and connected to the inlet waterway;
A power generation mechanism, it is fixed in the fixing unit and generate electric energy by the impact of the water flow in the inlet waterway;
A fast energy storage component, it is used for storing electric energy generated by the power generation mechanism;
A control unit, it comprises a control circuit and a control module which is used for activating the control circuit;
The control circuit, fast energy storage component, electric-control valve and the power generation mechanism are in electric-connection, the electric energy generated by the power generation mechanism is stored by the fast energy storage component after rectification, the control circuit gets the electric energy through the fast energy storage component and controls the on and off of the electric-control valve.

2. A water outlet device of self power generation according to claim 1, wherein said power generation mechanism comprises a generator, an impeller and a drive body disposed with an outlet water hole and an oblique water hole which is connected to the inlet waterway, the impeller is fixed in the drive body and connected to the shaft of the generator.

3. A water outlet device of self power generation according to claim 2, wherein said impeller is in turbo structure.

4. A water outlet device of self power generation according to claim 2, wherein said driving body comprises a drive plate disposed with said oblique water hole and a hollow shell disposed with said outlet water hole, the hollow shell is fixed to the case of the generator or in the integrated mold with the case of the generator, the drive plate is connected to the hollow shell and cover on it.

5. A water outlet device of self power generation according to claim 1, wherein said fast energy storage component is a super capacitor.

6. A water outlet device of self power generation according to claim 1, wherein said control module is a touch panel or an infrared sensing module which is in electric connection with said control circuit; or, said control module can be a remote controller which could communicate with said control circuit in wireless way.

7. A water outlet device of self power generation according to claim 1, wherein said fixing unit comprises a base, a top cover with an inlet hole and a side cover, the base is disposed with a first cavity and at least one second cavity which is communicating with the first cavity; said power generation mechanism is installed in the first cavity, the top cover is covered on the base and cooperated with the base to form the inlet waterway connected to the first cavity; said electric-control valve is set in the second cavity, said first outlet waterway is formed on the base near the outlet hole of the electric-control valve and is connected to the outlet hole of the electric-control valve; the side cover blocks the first cavity from the side and helps to form said second outlet waterway connected to the first cavity; the connection wiring terminal of said power generation mechanism can go through out of the side cover.

8. A water outlet device of self power generation according to claim 1, wherein said fixing unit is a shower body, the shower body is also provided with water outlet function which is in one-to-one correspondence connection with said first outlet waterway and second outlet waterway, said control circuit and fast energy storage component are installed in the shower body, said control module is fixed out of the shower body, or, said control module can be a remote controller which could communicate with said control circuit in wireless way.

9. A water outlet device of self power generation according to claim 1, wherein also comprises a shower body of at least two water outlet function; said fixing unit is installed in the shower body, inlet waterway of said fixing unit is connected to the inlet end of the shower body, the first outlet waterway and second outlet waterway of said fixing unit are in one-to-one correspondence connection with the water outlet function of the shower body; said control circuit and fast energy storage component are installed in the shower body or the fixing unit, said control module is fixed out of the shower body, or, said control module can be a remote controller which could communicate with said control circuit in wireless way.

10. A water outlet device of self power generation, wherein it comprises:
A fixing unit, it has an inlet waterway and at least two outlet waterway, and each outlet waterway is connected to the inlet waterway through an electric-control valve;
A power generation mechanism, it is fixed in the fixing unit and generate electric energy by the impact of the water flow in the inlet waterway;
A fast energy storage component, it is used for storing electric energy generated by the power generation mechanism;
A control unit, it comprises a control circuit and a control module which is used for activating the control circuit;
The control circuit, fast energy storage component, electric-control valve and the power generation mechanism are in electric-connection, the electric energy generated by the power generation mechanism is stored by the fast energy storage component after rectification, the controls the on and off of each of the electric-control valves, and at least one electric-control valve is normally in on status, or, when said inlet waterway stops getting water inlet, the control circuit can control at least one electric-control valve to keep in on status.

11. A water outlet device of self power generation according to claim 10 wherein said power generation mechanism comprises a generator, an impeller and a drive body disposed with an outlet water hole and an oblique water hole which is connected to the inlet waterway, the impeller is fixed in the drive body and connected to the shaft of the generator.

12. A water outlet device of self power generation according to claim 11, wherein said impeller is in turbo structure.

13. A water outlet device of self power generation according to claim 10, wherein said fast energy storage component is a super capacitor.

14. A water outlet device of self power generation according to claim 10, wherein said fixing unit comprises a base, a top cover with an inlet hole and a side cover, the base is disposed with a first cavity and at least two second cavity each of which is communicating with the first cavity respectively; said power generation mechanism is installed in the first cavity, the top cover is covered on the base and cooperated with the base to form the inlet waterway connected to the first cavity; one said electric-control valve is connected in each of the second cavity, said first outlet waterway is formed on the base near the outlet hole of the electric-control valve and is connected to the outlet hole of the electric-control valve; the side cover blocks the first cavity from the side, the connection wiring terminal of said power generation mechanism can go through out of the side cover.

15. A water outlet device of self power generation according to claim 10, wherein said fixing unit is a shower body, the shower body is also provided with water outlet function which is in one-to-one correspondence connection with said at least two outlet waterway, said control circuit and fast energy storage component are installed in the shower body, said control module is fixed out of the shower body, or, said control module can be a remote controller which could communicate with said control circuit in wireless way.

16. A water outlet device of self power generation according to claim 10. wherein also comprises a shower body of at least two water outlet function; said fixing unit is installed in the shower body, inlet waterway of said fixing unit is connected to the inlet end of the shower body, the outlet waterways of said fixing unit are in one-to-one correspondence connection with the water outlet function of the shower body; said control circuit and fast energy storage component are installed in the shower body or the fixing unit, said control module is fixed out of the shower body, or, said control module can be a remote controller which could communicate with said control circuit in wireless way.
